(19) United States
(12) Patent Application Publication
(10) Pub. No.: US 2024/0038978 A1
(43) Pub. Date: Feb. 1, 2024

(54) TITANIUM-NIOBIUM COMPOSITE OXIDE, ITS PREPARATION METHOD, ACTIVE SUBSTANCE AND LITHIUM ION SECONDARY BATTERY USING THE SAME

(71) Applicant: GUS TECHNOLOGY CO., LTD., New Taipei (TW)

(72) Inventors: Chung-Chieh CHANG, New Taipei (TW); Kuo-Wei YEH, New Taipei (TW); Wen-Chia HSU, New Taipei (TW); Jia-Hui WANG, New Taipei (TW); Chia-Huan CHUNG, New Taipei (TW); Dong-Ze WU, New Taipei (TW); PREM CHANDAN DEVANGA, New Taipei (TW)

(73) Assignee: GUS TECHNOLOGY CO., LTD., New Taipei (TW)

(21) Appl. No.: 18/165,305

(22) Filed: Feb. 6, 2023

(30) Foreign Application Priority Data
Jul. 27, 2022 (TW) 111128172

(51) Int. Cl. H01M 4/485; H01M 10/0525; C01G 33/00

(52) U.S. Cl. CPC H01M 4/485; H01M 10/0525; C01G 33/006; H01M 2004/027

(57) ABSTRACT

The present invention provides a titanium-niobium composite oxide, which includes titanium, niobium, dopant M and oxygen, and the molar ratio of the titanium, niobium and dopant M is 1:(2−x):x, and x is 0.01 to 0.2; wherein the dopant M is doped in a crystal structure with a monoclinic crystal structure formed from the titanium, niobium and oxygen, and the dopant M is at least one metal element selected from the group consisting of Sn, Al and Zr. The present invention further provides a preparation method of the titanium-niobium composite oxide, an active material and a lithium ion secondary battery using the same. The titanium-niobium composite oxide produced by the present invention has better electrical performance than the existing negative electrode materials, so that the lithium ion secondary battery using it can exhibit longer cycle life, larger electric capacity and faster charging and discharging performance, thereby having a bright prospect of the application.

### CROSS-REFERENCE TO RELATED APPLICATIONS

This application claims priority to Taiwan Patent Application No. 111128172, filed on Jul. 27, 2022, the contents of which are hereby incorporated by reference.

### FIELD OF THE INVENTION

The present invention relates to a technical field of battery electrode materials, especially to a titanium-niobium composite oxide, its preparation method, and an active substance and a lithium ion secondary battery using the same.

### BACKGROUND OF THE INVENTION

Recently, energy storage electronic products bring convenience to modern life, which makes secondary batteries with repeated charge and discharge function an indispensable necessity. Among them, the lithium ion secondary batteries are used the most widely. Currently, however, the capacity and charge and discharge rate of existing lithium-ion secondary batteries are gradually unable to meet the demand.

Currently, lithium titanate has been studied to replacing the conventional negative electrode materials to provide good cycle life and rate discharging capability, but it has a low theoretical specific capacitance (170 mAh/g) and is very limited in improving the energy density of a lithium ion secondary battery.

Additionally, titanium-niobium oxide (TiNb₂O₇) has become a negative electrode material of interest due to the good cycle life and the working voltage similar to lithium titanate. Although the titanium-niobium oxide has a high theoretical specific capacitance (270 mAh/g), it has a band gap which is so large to result in poor electrical conductivity, and has no significant performance in a high rate capability test.

Given aforementioned, it is necessary to propose a negative electrode material with good cycle life, high electric capacity and fast charging and discharging rate to meet the actual needs of the industry.

### SUMMARY OF THE INVENTION

In order to solve the problems described above, the present invention provides a titanium-niobium composite oxide which comprises titanium, niobium, dopant M and oxygen, and a molar ratio of the titanium, niobium and the dopant M is 1:(2−x):x, and x is 0.01 to 0.2, wherein the dopant M is doped in a crystal structure with a monoclinic crystal structure formed from the titanium, niobium and oxygen, and the dopant M is at least one metal element selected from the group consisting of Sn, Al and Zr.

In one embodiment of the titanium-niobium composite oxide of the present invention, the crystal structure has the a-axis lattice constant of 20.375 Å to 20.415 Å, the b-axis lattice constant of 3.798 Å to 3.806 Å, and the c-axis lattice constant of 11.897 Å to 11.920 Å.

In one embodiment of the titanium-niobium composite oxide of the present invention, the titanium-niobium composite oxide are particles having a number average particle size of 1.5 to 1.9 μm.

The present invention further provides a preparation method of the titanium-niobium composite oxide described above, comprising: providing a first reaction solution and a second reaction solution, respectively, wherein the first reaction solution comprises a solvent, more than two acid agents and a surfactant; the second reaction solution comprises a solvent and precursor salts dissolved in the second solvent, and the precursor salts comprise a titanium-containing metal salt, a niobium-containing metal salt and an M-containing metal salt, in which the M is at least one metal element selected from the group consisting of Sn, Al and Zr; mixing the first and the second reaction solutions in batches to form a mixed solution; and subjecting the mixed solution to hydrolysis and condensation reactions to prepare the titanium-niobium composite oxide.

In one embodiment of the preparation method of the present invention, the first solvent and the second solvent are each at least one selected from the group consisting of deionized water, ethanol, isopropanol and tetrahydrofuran.

In one embodiment of the preparation method of the present invention, the titanium-containing metal salt is at least one selected from the group consisting of titanium isopropoxide, titanium citrate, titanium oxysulfate, titanium butoxide and titanium tetrachloride.

In one embodiment of the preparation method of the present invention, the niobium-containing metal salt is at least one selected from the group consisting of niobium isopropoxide, niobium pentachloride, niobium ethoxide and niobium hydroxide.

In one embodiment of the preparation method of the present invention, the M-containing metal salt is at least one selected from the group consisting of tin chloride, aluminum isopropoxide, aluminum trichloride, aluminum sulfate, aluminum acetate, aluminum acetylacetonate, zirconium acetylacetonate, zirconium isopropoxide and zirconium acetate.

In one embodiment of the preparation method of the present invention, the surfactant is at least one selected from the group consisting of polyoxyethylene-polyoxypropylene block copolymer, polyethylene glycol octylphenyl ether and hexadecyltrimethylammonium bromide.

In one embodiment of the preparation method of the present invention, the second reaction solution is added dropwise to the first reaction solution in batches for mixing, with the titanium-containing metal salt in the second reaction solution is added dropwise at a rate of 0.06 to 0.10 moles/minute.

In one embodiment of the preparation method of the present invention, the precursor salts are included in the mixed solution at a molarity of 20 to 25 M, and a molar ratio of the surfactant and the titanium-containing metal salt in the mixed solution is 0.02:1 to 0.04:1.

In one embodiment of the preparation method of the present invention, the acid agents comprise at least two acids selected from the group consisting of sulfuric acid, hydrochloric acid, nitric acid and acetic acid.

In one embodiment of the preparation method of the present invention, the acid agents are hydrochloric acid and acetic acid, and a volume ratio of the hydrochloric acid and the acetic acid in the first reaction solution is 0.1:1 to 1:1.

In one embodiment of the preparation method of the present invention, the mixed solution has a pH value of 1 to 6.

In one embodiment of the preparation method of the present invention, the hydrolysis and condensation reactions are performed at a temperature of 80 to 100° C. for 1 to 6 hours.

In one embodiment of the preparation method of the present invention, the preparation method of the titanium-niobium composite oxide further comprises subjecting the titanium-niobium composite oxide to treatments of drying, sintering and grinding sequentially after the hydrolysis and condensation reactions.

In one embodiment of the preparation method of the present invention, the drying treatment is performed continuously at a temperature of 50 to 150° C. for 6 to 48 hours.

In one embodiment of the preparation method of the present invention, the sintering treatment is performed continuously at a temperature of 800 to 1400° C. for 3 to 20 hours.

In one embodiment of the preparation method of the present invention, the preparation method further comprises allowing the sintered titanium-niobium composite oxide to cool down at a cooling rate of 4.5 to 8° C./minute prior to the grinding treatment.

In one embodiment of the preparation method of the present invention, the grinding treatment is performed by ball milling for 2 to 20 hours.

The present invention further provides an active substance used for a negative electrode of a lithium ion secondary battery, comprising the titanium-niobium composite oxide described above.

The present invention further provides a lithium ion secondary battery, comprising: a positive electrode; a negative electrode comprising the active substance described above; and an electrolyte located between the positive and the negative electrodes.

According to the present invention, by the introduction of the dopant M, the impurity band of Fermi level is formed, and the band gap between the conduction band and the valence band is reduced, so as to improve the electrical conductivity. Also, the embedding of the dopant M extends the crystal structure space, so that a lithium ion secondary battery using the same has a reduced internal resistance for lithium ions embedding, and thus exhibits a high lithiation rate.

In another aspect, the present invention further provides a preparation method of optimized titanium-niobium composite oxide described above: (1) performing the procedure of mixing reaction solution in a manner of adding dropwise, and controlling the reaction speed for generating the titanium-niobium composite oxide to allow the titanium-niobium composite oxide, thereby forming an optimized arrangement pattern; (2) imparting a more refined particle size, a high distribution uniformity and a more consistent crystal structure to the prepared titanium-niobium composite oxide through selecting a particular sintering temperature range; and (3) conducting a temperature dropping procedure in a particular cooling rate range, and controlling the crystal nucleation and growth rate of the titanium-niobium composite oxide to optimize its crystal structure, resulting in that a lithium ion secondary battery using the prepared titanium-niobium composite oxide has an effectively reduced internal resistance for lithium ion embedding and improved electrical performance. By the technical means described above, a titanium-niobium composite oxide having good electrical performance is provided, which is capable of exhibiting a longer cycle life, a larger electrical capacity and a faster charging and discharging performance, thereby having a bright prospect of the application.

### BRIEF DESCRIPTION OF THE DRAWINGS

The execution modes of the present invention will be described through exemplary drawings:

FIG. 1 shows the crystal structure identified by an X-ray diffraction analyzer, wherein (A) is for a titanium-niobium oxide having no dopant added; and (B) is for a titanium-niobium composite oxide having a dopant Al with the introduction amount x of 0.07;

FIG. 2 is a flow chart of the preparation method of the titanium-niobium composite oxide of the present invention;

FIG. 3 are images showing surface topographies observed by a scanning electron microscope, wherein (A) is of a titanium niobium oxide having no dopant added; (B) is of a titanium-niobium composite oxide having a dopant Al with an introduction amount x of 0.03; (C) is of a titanium-niobium composite oxide having a dopant Al with an introduction amount x of 0.05; and (D) is of a titanium-niobium composite oxide having a dopant Al with an introduction amount x of 0.07;

FIG. 4 are X-ray diffraction spectra detected by an X-ray diffraction analyzer, wherein (A) is of the titanium niobium oxide of Experimental Example 1; (B) is of the titanium-niobium composite oxide of Example 1; (C) is of the titanium-niobium composite oxide of Example 2; (D) is of the titanium-niobium composite oxide of Example 3; and (E) is the reference information provided by a data library (JCPDS: 77-1374);

FIG. 5 is a diagram showing the cycle stabilities of the lithium ion secondary batteries from Experimental Examples 1 to 4;

FIG. 6 are X-ray diffraction graphs detected by an X-ray diffraction analyzer, wherein (A) is of the titanium niobium oxide of Experimental Example 1; (B) is of the titanium-niobium oxide of Experimental Example 3; and (C) is the reference information provided by a data library (JCPDS: 77-1374);

FIG. 7 is a graph showing the locally scale-up view of the X-ray diffraction spectra of the titanium niobium oxide from Experimental Examples 1 and 4;

FIGS. 8A to FIG. 8D are cyclic voltammograms of lithium ion secondary batteries, wherein FIG. 8A is of the titanium niobium oxide of the Comparative Example; FIG. 8B is of the titanium-niobium composite oxide of Example 1; FIG. 8 C is of the titanium-niobium composite oxide of Example 2; and FIG. 8D is of the titanium-niobium composite oxide of Example 3;

FIG. 9 is a graph showing impedance diagrams of the lithium ion secondary batteries of the Examples and the Comparative Example of the present invention;

FIG. 10 is a graph showing the rate discharging performance of the lithium ion secondary batteries of the Examples and Comparative Example of the present invention;

FIG. 11 is a graph showing the long-term charging and discharging cycle stabilities of the lithium ion secondary batteries of the Examples and Comparative Example of the present invention; and

FIG. 12 is a graph showing the rate charging and discharging performance (locally scale-up view) of the lithium ion secondary battery of Example 4 of the present invention and the long-term charging and discharging cycle stability at a rate of 0.1 C; and

FIG. 13 is a graph showing the long-term charging and discharging cycle stability at a rate of 0.2 C after 10 cycles at a rate of 0.1 C.

### DETAILED DESCRIPTION

The execution modes of the present invention will be illustrated by following specific embodiments, anyone skilled in the art can easily realize the advantages and effects of the present invention based on the content described in the description. The present invention also can be performed or applied by other different execution modes, and the details of the present invention each can be imparted with different modifications and alternations based on different views and applications without departing from the scope described by the present invention. Furthermore, all ranges and values recited in the present invention are inclusive and combinable. Any value or point falling in the ranges recited herein, such as any integers, can be used as the lower or upper limit to derive a subrange.

According to the present invention, a titanium-niobium composite oxide comprises titanium, niobium, a dopant M and oxygen, with a molar ratio of the titanium, niobium and the dopant M is 1:(2−x):x and x is 0.01 to 0.2, wherein the x is the introduction amount of the dopant M, and the dopant M is at least one metal element selected from the group consisting of Sn, Al and Zr. In the present invention, the dopant M at a minor amount can change its energy band structure, reduce the distance between the conduction band and the valence band, and thus improve its electrical performance.

In one embodiment, the dopant M of the titanium-niobium composite oxide is Al or Zr, and the molar ratio of the titanium, niobium and the dopant M is 1:(2−x):x and x ranges from 0.01 to 0.1; in other embodiment, the x can be 0.03, 0.05, or 0.07, but not limited thereto.

In the present invention, the titanium-niobium composite oxide has a crystal structure. Herein, the “crystal structure” is formed by a plurality of unit cells in a continuously extending arrangement, and the skeleton of the unit cell is composed of the titanium, niobium and oxygen elements, however, it is not limited to a symmetric structure but can includes an asymmetric aberrant structure.

In one embodiment, the titanium-niobium composite oxide of the present invention has a monoclinic crystal structure which is in an ReO₃ configuration formed by TiO₆ octahedrons and NbO₆ octahedrons sharing edges and angles, wherein the crystal structure is an AB₂O₇ structure having space groups C2/m, with the A is titanium and the B is niobium, and has no restriction on change in ion valences therein.

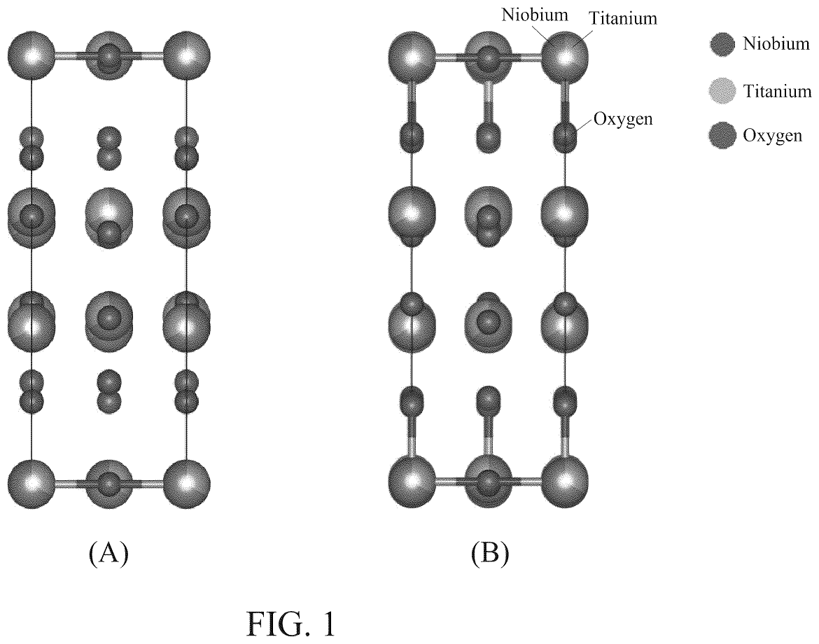

It has been identified by an X-ray diffraction analyzer that the dopant M is doped in the monoclinic crystal structure formed by titanium, niobium and oxygen. In one example, FIG. 1(B) provides the identification result of an exemplary titanium-niobium composite oxide having a dopant Al, which shows no change in ratio of the titanium, niobium and oxygen in the skeleton of the crystal structure when the dopant Al is introduced at an amount of 0.07 compared with the one having no dopant added (A). Specifically, the dopant M is embedded into the void sites in the crystal structure describe above rather than replacing any element in the skeleton.

In the case of the crystal structure characteristics described above, the axis sizes and volume of the unit cell are further resolved, the use and selection of the dopant are showed to provide an effect of “extending the crystal structure space” compared to those having no dopant added. In one embodiment, the titanium-niobium composite oxide of the present invention has a crystal structure with the a-axis lattice constant of 20.375 Å to 20.415 Å, the b-axis lattice constant of 3.798 Å to 3.806 Å and the c-axis lattice constant of 11.897 Å to 11.920 Å; in another embodiment, the titanium-niobium composite oxide of the present invention has a crystal structure with a volume of 795.716 Å³ to 800.181 Å³. The accuracy of the values described above has been ensured, but the experimental errors and deviations still need to be considered.

In one example, when any dopant is not introduced, the crystal structure has the a-axis lattice constant of 20.3766 Å, the b-axis lattice constant of 3.79981 Å and the c-axis lattice constant of 11.89960 Å and has an overall crystal structure volume of 795.9297 Å³. When the dopant is Al, the titanium-niobium composite oxide has a crystal structure with the a-axis lattice constant of 20.3820 Å to 20.415 Å, the b-axis lattice constant of 3.799 Å to 3.806 Å and the c-axis lattice constant of 11.904 Å to 11.920 Å; wherein the titanium-niobium composite oxide has a crystal structure with a volume of 796.00 Å³ to 796.45 Å³. In another example, when the dopant is Zr, the titanium-niobium composite oxide has a crystal structure with the a-axis lattice constant of 20.400 Å to 20.415 Å, the b-axis lattice constant of 3.802 Å to 3.806 Å and the c-axis lattice constant of 11.911 Å to 11.920 Å; wherein the titanium-niobium composite oxide has a crystal structure with a volume of 798.400 Å³ to 800.181 Å³.

By embedding the dopant M to extend the crystal structure spaces, the internal resistance for lithium ions embedding is reduced and therefore the lithiation rate is improved in application of lithium ion secondary batteries.

The changes in lithiation rate caused by the introduction of dopants are specifically described as follows: when any dopant is not introduced, the lithiation rate is 4.69e-9. In one example, when the dopant Al is introduced and the introduced amount is 0.03 to 0.07, the lithiation rate can reach 5.1e-9 to 6.6e-9, suggesting that the use of dopant M has a significant effect on improving the lithiation rate.

In another aspect, the whole the titanium niobium oxide presents only a monoclinic crystal structure without existing of other phases when the introduction amount x of the dopant Al is 0.03 to 0.07 compared to the material having no dopant, i.e., the titanium-niobium composite oxide of the present invention has a monoclinic crystal structure in a pure single phase state, exhibiting the characteristics of consistent crystal arrangement, and therefore, it is possible to avoid the defects caused by the incomplete crystal phase from affecting the electrical conductivity of the material.

Additionally, in one embodiment, by the preparation method of the present invention, the titanium-niobium composite oxide of the present invention exhibits a ratio of the diffraction intensity on the lattice plane (110) to that on the lattice plane (003) ranges from 1 to 1.2, thereby providing an excellent and stable electrical performance in application of lithium ion secondary batteries.

The surface morphology and particle size of the titanium-niobium composite oxide can be detected through a scanning electron microscope.

The titanium-niobium composite oxide of the present invention comprises a plurality of particles, wherein the shapes of the plurality of particles have no particular restriction and can be any one including spheres, blocks, columns etc. The measurement for particle size of the titanium niobium composite oxide according to the present invention is a statistical result within a field of view with a magnification of 10000 times. If the shape of the particle is not spherical, the longest radial distance of the particle is measured. In the present invention, the number average particle size of the plurality of particles of the titanium niobium composite oxide is 1.5 to 1.9 μm.

In other embodiments, the number average particle size of the plurality of the titanium-niobium composite oxide can be 1.55, 1.60, 1.65, 1.70, 1.75, 1.8 or 1.85 μm, but not limited thereto. Also, the value can be the upper or lower limit of the number average particle size, e.g., the titanium-niobium composite oxides are particles having the number average particle size of 1.5 to 1.85 μm.

The uniformity of particle size distribution is evaluated by the value of the standard deviation from the average, and the value of the standard deviation is calculated from the particle size statistics. In still another embodiment, the particle size distribution of the titanium-niobium composite oxide of the present invention has a standard deviation of 0.32 to 0.34 suggesting that the titanium-niobium composite oxide of the present invention has a very high uniformity.

By the introduction of the dopant M, the titanium-niobium composite oxide of the present invention has an extended crystal structure and a reduced band gap between the conduction bang and the valence band, meanwhile, the crystal arrangement, the crystallinity and the size of the formed particles are optimized, thereby effectively solving the inherent electrical conductivity problem of the conventional titanium niobium oxide (TiNb₂O₇) and providing high charging and discharging cycle capability.

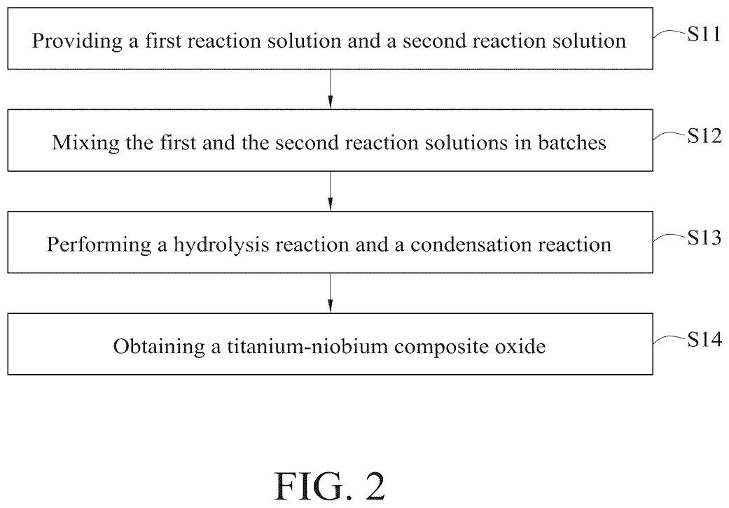

For the titanium-niobium composite oxide described above, the present invention further provides a preparation method of the titanium-niobium composite oxide described above, see FIG. 2, a flow chart depicting the preparation method of the titanium-niobium composite oxide of the present invention. First, a first and a second reaction solutions are provided, respectively (Step S11); thereafter, the first and the second reaction solutions are mixed in batches to form a mixed solution (Step S12); and the mixed solution is subjected to hydrolysis and condensation reactions (Step S13) to prepare the titanium-niobium composite oxide (Step S14).

The first reaction solution comprises a solvent, more than two acid agents and a surfactant. The second reaction solution comprises a solvent and precursor salts dissolved in the second solvent, and the precursor salts comprise a titanium-containing metal salt, a niobium-containing metal salt and an M-containing metal salt, in which the M is at least one metal element selected from the group consisting of Sn, Al and Zr. In one example, the metal salt is at least one selected from the group consisting of a metal alkoxide, a metal citrate, a metal acetate, a metal sulfate, a metal oxysulfate, a metal halide, a metal acetylacetonate and a metal hydroxide. In another example, the metal halide is a metal chloride.

For formulation of the first and the second reaction solutions, in one embodiment, the first and the second reaction solutions are both formulated by dissolving thoroughly the solid materials in the solutions under stirring to form a uniform phase.

The solvent is at least one selected from the group consisting of deionized water, ethanol, isopropanol and tetrahydrofuran; wherein the solvents of the first and the second reaction solutions can be the same or different; in one embodiment, the solvents of the first and the second reaction solutions are the same and both are ethanol.

In one embodiment, the titanium-containing metal salt is at least one selected from the group consisting of titanium metal alkoxide, titanium metal citrate, titanium metal oxysulfate and titanium halide. In another embodiment, the titanium-containing metal salt is at least one selected from titanium isopropoxide, titanium citrate, titanium oxysulfate, titanium butoxide and titanium tetrachloride. In still another embodiment, the titanium-containing metal salt is titanium isopropoxide.

In one embodiment, the niobium-containing metal salt is at least one selected from the group consisting of niobium metal alkoxide, niobium metal hydroxide and niobium metal halide. In another embodiment, the niobium-containing metal salt is at least one selected from the group consisting of niobium isopropoxide, niobium pentachloride, niobium ethoxide and niobium hydroxide. In still another embodiment, the niobium-containing metal salt is niobium ethoxide.

In one embodiment, the M-containing metal salt is at least one selected from the group consisting of M metal alkoxide, M metal sulfate, M metal acetate, M metal halide and M metal aceylacetonate; in another embodiment, the M-containing metal salt is at least one selected from the group consisting of tin chloride, aluminum isopropoxide, aluminum trichloride, aluminum sulfate, aluminum acetate, aluminum acetylacetonate, zirconium acetylacetonate, zirconium isopropoxide and zirconium acetate; in another embodiment, the M-containing metal salt is aluminum acetylacetonate or zirconium acetylacetonate.

The acid agents are at least two acids selected from the group consisting of sulfuric acid, hydrochloric acid, nitric acid and acetic acid. In one embodiment, the acid agents are hydrochloric acid and acetic acid, and the volume ratio of the hydrochloric acid and the acetic acid in the first reaction solution is 0.1:1 to 1:1.

Herein, the “surfactant” forms micelles in a particular pH range, which, as shaping templates, direct titanium, niobium and the dopant M to join together following a particular proportion, thereby forming a titanium-niobium composite oxide having a monoclinic crystal structure with the dopant M embedded therein. In one embodiment, the surfactant is a block copolymer or a quaternary ammonium salt having C12-18 linear alkyl segments. In another embodiment, the surfactant is at least one selected from the group consisting of polyoxyethylene-polyoxypropylene block copolymer, polyethylene glycol octylphenyl ether and hexadecyltrimethylammonium bromide, wherein the polyoxyethylene-polyoxypropylene block copolymer has a weight average molecular weight of 150 to 200 g/mol, the polyethylene glycol octylphenyl ether has a weight average molecular weight of 600 to 700 g/mol, and the hexadecyltrimethylammonium bromide has a molecular weight of 364.45 g/mol.

For the manner by which the first and the second reaction solutions are mixed in batches, in one embodiment, the present invention employs a manner of “adding dropwise” for mixing, to control the reaction rate, to reduce defects in the crystal structure or generation of impurities, and to make the prepared titanium-niobium composite oxide to form an optimal arrangement, thereby exhibiting excellent cycle stability in application of lithium ion secondary batteries.

In one embodiment, the procedure of mixing in batches is adding the second reaction solution dropwise to the first reaction solution, wherein the titanium-containing metal salt in the second reaction solution is added dropwise at a rate of 0.06 to 0.10 moles/minute, and the temperature condition for the adding dropwise is 20 to 40° C. In other embodiments, the titanium-containing metal salt in the second reaction solution can be added dropwise at a rate of 0.065, 0.07, 0.075, 0.08, 0.085, 0.09 or 0.095 moles/minute, but not limited thereto. In another embodiment, the procedure of mixing in batches can be performed by adding the first reaction solution dropwise to the second reaction solution.

In another embodiment, after the mixing procedure is completed, the precursor salts are included in the mixed solution at a molarity of 20 to 25 M, and molar ratio of the surfactant and the titanium-containing metal salt in the mixed solution is 0.02:1 to 0.04:1.

In still another embodiment, after the mixing procedure is completed, the mixed solution has a pH value of 1 to 6. In other embodiments, the mixed solution can have a pH value of 2, 3, 4 or 5, but not limited thereto.

Herein, the “hydrolysis and condensation reactions” are reaction processes occurring at the same time. The specific reaction steps include that a precursor reactant is subjected to a hydrolysis reaction to generate an intermediate, and the intermediate preliminarily condensed first to form colloid particles which further condensed to form a 3-dimensional net structure. In one embodiment, the hydrolysis and condensation reactions are performed at a temperature of 80 to 100° C. for 1 to 6 hours. In other embodiments, the hydrolysis and condensation reactions can be performed at a temperature of 85, 90 or 95° C. for 1.5, 2, 2.5, 3, 3.5, 4, 4.5, 5 or 5.5 hours, but not limited thereto.

In one embodiment, the preparation method of the present invention further comprises, after the preparation processes aforementioned, subjecting the titanium-niobium composite oxide to sequential treatments of drying and sintering to form the titanium-niobium composite oxide with an optimal crystal arrangement.

In one example, the drying treatment is performed continuously at a temperature of 50 to 150° C. for 6 to 48 hours. In other embodiments, the drying treatment can be performed at a temperature of 60, 70, 80, 90, 100, 110, 120, 130, or 140° C. for 12, 18, 24, 30, 36 or 42 hours, but not limited thereto.

In one example, the sintering treatment is performed continuously at a temperature of 800 to 1400° C. for 3 to 20 hours. In one example, the sintering treatment is performed at a temperature higher than or equal to 1000° C. to less than 1400° C. Through selection of the particular sintering temperature range, the prepared titanium-niobium composite oxide has more refined particle sizes, high distribution uniformity and more consistent crystal structure. In another example, the sintering treatment is performed at a temperature of 1100° C. to 1300° C. to optimize the crystal structure formed by the titanium-niobium composite oxide of the present invention. In other embodiments, the sintering treatment can be performed at a temperature of 1150, 1200, 1230, 1250, or 1270° C. for 5, 7, 10, 12, 15 or 17 hours, but not limited thereto.

After the sintering treatment is completed, the present invention further comprises conducting a cooling procedure at a particular rate to control the crystal nucleation and growth rate of the titanium-niobium composite oxide, thereby optimizing its crystal structure, and thus the prepared titanium-niobium composite oxide is capable of effectively reducing the internal resistance for lithium ions embedding in application of lithium ion secondary batteries. In one example, the cooling rate after sintering is 4.5 to 8° C./min∘ In other embodiments, the cooling rate after sintering can be 5, 5.5, 6, 6.5, 7 or 7.5° C./min, but not limited thereto.

In another embodiment, the preparation method of the present invention further comprises, after the drying and sintering treatment are completed, subjecting the titanium-niobium composite oxide to a grinding treatment to control the particle size distribution of the titanium-niobium composite oxide. In one example, the grinding treatment is performed by ball milling for 2 to 20 hours. In other embodiments, the treatment can be performed for 5, 7, 10, 12, 15 or 17 hours, but not limited thereto.

In another aspect, the present invention further provides an active substance used for a negative electrode of a lithium ion secondary battery, comprising the titanium-niobium composite oxide described above. Also, the present invention further provides a lithium ion secondary battery, comprising: a positive electrode; a negative electrode; and an electrolyte located between the positive and the negative electrodes; wherein the negative electrode comprises the active substance described above, resulting in that the lithium ion secondary battery of the present invention has a lithiation rate of 5.1e-9 to 6.6e-9.

In one embodiment, the titanium-niobium composite oxide is included in the negative electrode at a weight percentage of 60 to 90 wt %.

In another embodiment, the negative electrode further comprises an electrical conductive material and an adhesive, and commonly used materials can be selected for the electrical conductive material and the adhesive. In one example, the electrical conductive material is at least one selected from the group consisting of acetylene carbon, conductive carbon and carbon nanotube. The adhesive is one of the group consisting of styrene butadiene rubber, carboxymethyl cellulose, polyacrylic acid, polyvinylidene fluoride, sodium alginate and pectin.

The titanium-niobium composite oxide provided by the present invention has properties including good electrical conductivity and excellent crystal structure, so that the active substance and the lithium ion secondary battery using it can exhibit longer cycle life, larger electric capacity and faster charging and discharging performance, thereby having a bright prospect of the application.

The features and effects of the present invention will be described in detail through Examples which are not considered to restrict the scope of the present invention.

The characteristics of the products obtained from Examples and the Comparative Example were analyzed according to following methods.
(1) Surface observation and particle size analysis: The products were observed under a scanning electron microscope (Thermo Fisher, FEI Inspect-F) for their morphologies, their particle sizes were counted within a view field with a magnification of 10000 times, and the standard deviation was calculated from the particle size statistics to evaluate the uniformity of particle size distribution.
(2) Analysis of crystal properties: The products were analyzed by an X-ray diffraction analyzer (Malvern Panalytical, Empyrean) for their crystal structure and the results were compared to a standard data library (JCPDS: 77-1374). After resolution with Highscore and Fullprof softwares, informations on ratio of lattice plane diffraction intensities, axis size and volume of each unit cell were further obtained.

Additionally, the lithium ion secondary batteries prepared in Examples and the Comparative Example were determined according to the following methods.
(1) Cyclic voltammetry test: Voltammograms were obtained by using an electrochemical impedance analyzer (PARSTA, PMC-1000) to perform multiple sweep cycles with a potential sweep rate set at 0.1 mV/S under sweep voltages ranging from 0 to 3 V.
(2) Lithiation rate: A battery was evaluated for lithium embedding, deembedding and other electrochemical properties by performing sweep cycles under sweep voltages ranging from 0 to 3 V with a potential sweep rate of 0.05 mV/S, 0.1 mV/S, 0.2 mV/S, 0.3 mV/S, 0.4 mV/S, 0.5 mV/S, respectively by using an electrochemical impedance analyzer (PARSTA, PMC-1000) and calculating its lithiation rate.
(3) Impedance: Nyquist plots were obtained by analyzing with an electrochemical Impedance analyzer (PARSTA, PMC-1000). In the plot, the arcs were the measured values of high frequencies which represented the resistance values of electrolyte conduction, with a larger arc representing a greater charge transfer resistance; and the oblique portions were the measured values of low frequencies which represented the diffusion resistances of lithium ions in the electrode materials, with a smaller slope of the oblique portion representing a greater diffusion resistance of lithium ions.
(4) Rate charging and discharging performance analysis: Electric capacities were determined under a charging and discharging rate of 0.1 C, 0.2 C, 0.5 C, 1 C, 3 C, 5 C, 10 C, respectively, by using a charging and discharging tester (Think Power, TPT-B1HC010A).
(5) Cycle stability: Multiple cycles of charging and discharging were repeated on a lithium battery at a temperature of 25° C. and a wording voltage ranging from 1 to 3 V by using a charging and discharging tester (Think Power, TPT-B1HC010A) and the electrical capacity of the lithium battery during each cycle was measured.

### Experiments for Parameters of the Preparation Method

### Experimental Example 1

Formulation of the first reaction solution: Hexadecyltrimethylammonium bromide (10 g) as the surfactant and hydrochloric acid (15 ml) and acetic acid (15 ml) as the acid agents were dissolved uniformly in ethanol as solvent to form the first reaction solution.

Formulation of the second reaction solution: A titanium metal salt which was titanium isopropoxide (8.52 g) and a niobium-containing metal salt which was niobium ethoxide (19.08 g) as the precursor salts were dissolved uniformly in ethanol as solvent to form the second reaction solution.

Procedures of mixing and reacting: The second reaction solution described above was added dropwise to the first reaction solution while the addition of the second reaction solution was controlled to allow the titanium isopropoxide therein to be added dropwise at a rate of 0.08 moles/minute for mixing, thereby forming a mixed solution. In the mixed solution described above, the precursor salts had a molarity of 23.07 M, the molar ratio of the titanium and niobium was 1:2, the molar ratio of the surfactant and the titanium isopropoxide was 0.0274:1, and the volume ratio of the hydrochloric acid and acetic acid was 1:1.

Thereafter, the mixed solution was transferred into a reaction kettle where it was warmed to 80° C. and held at the temperature, to perform the hydrolysis and condensation reactions for 3 hours while being stirred continuously.

Post-reaction treatment: After the reaction completed, the reaction kettle was allowed to cool to room temperature, yielding a crude product of titanium-niobium composite oxide. Thereafter, the prepared crude product of titanium-niobium composite oxide was placed in a vacuum oven at a temperature of 80° C. for 12 to perform a drying treatment, then was transferred into a Muffle furnace at a temperature of 1200° C. to perform a sintering treatment for 10 hours. After the sintering treatment ended, it was cooled at a rate of 6° C./min to room temperature to obtain a titanium-niobium oxide.

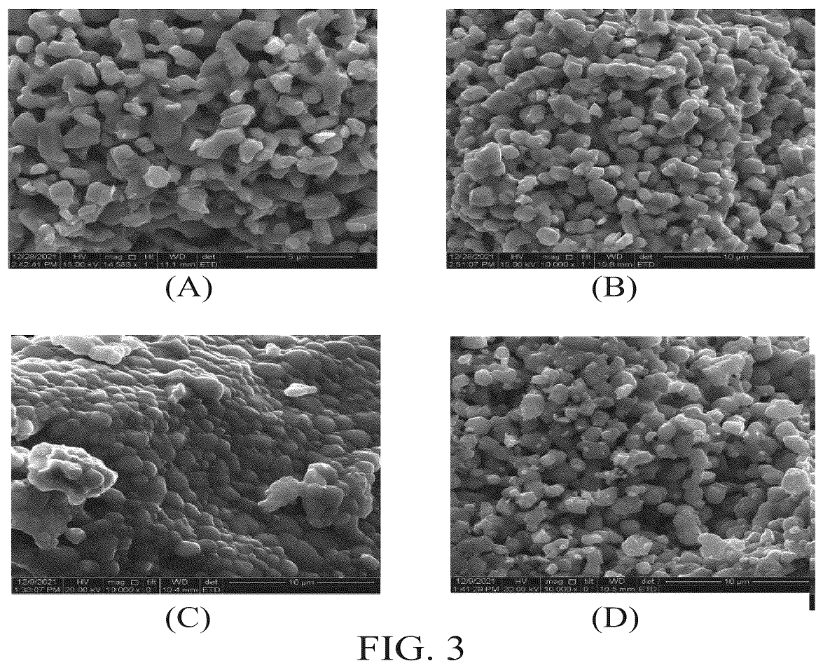

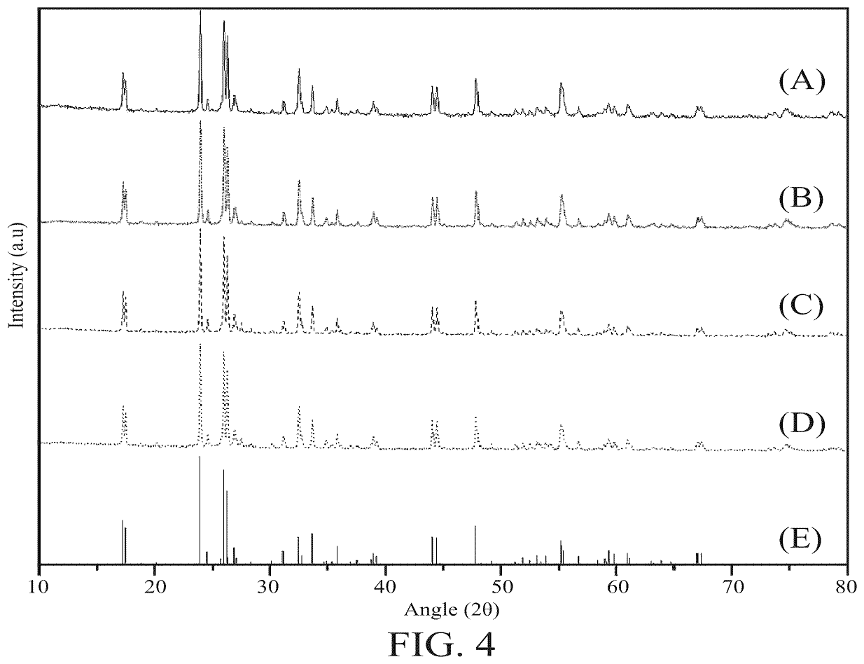

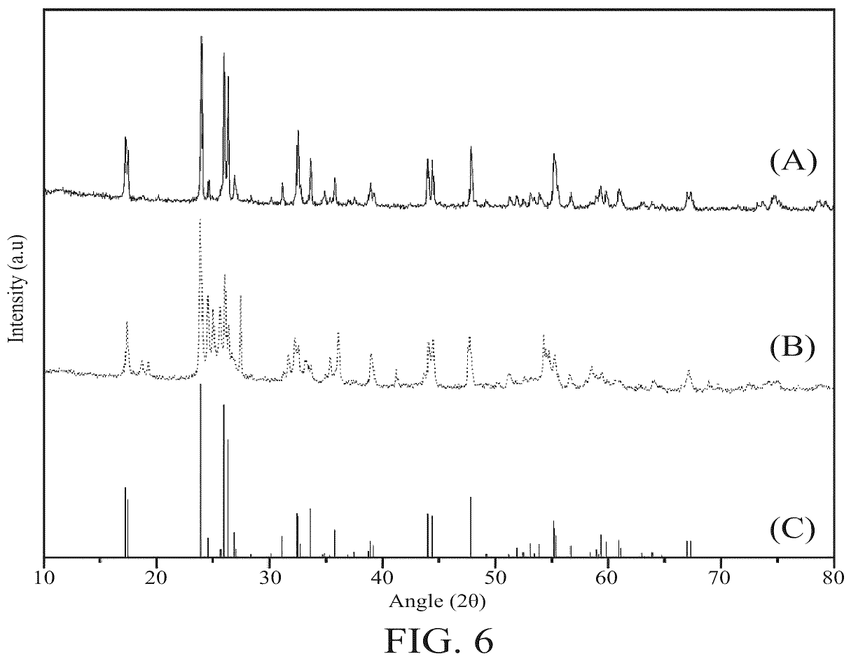

According to the analysis methods aforementioned, the titanium niobium oxide prepared above was subjected to surface observation and assays of particle size and crystal properties. The results of the surface observation and crystal properties were recorded in FIG. 1, FIG. 3, FIG. 4 and FIG. 6. Among them, the number average particle size was 2.3 μm and the standard derivation of its distribution was 0.32 μm. For the crystal properties, the ratio of diffraction intensity on lattice plane (110) to that on lattice plane (003) was 1.04±0.01.

Preparation of the negative material: First, the titanium niobium oxide prepared above as an active substance was subjected to a pretreatment comprising the following steps: the titanium niobium oxide (7 g) and conductive carbon (SuperP, KS6, each 1 g) were mixed and ground in a ball miller at a rate of 750 r.p.m. for 2 hours to form a mixture.

Thereafter, the ground mixture was mixed with polyvinylidene difluoride (PVDF) as an adhesive and N-methylpyrrolidone as a solvent to prepare a coating slurry; wherein contents of the components in the coating slurry expressed by weight percentages include titanium niobium oxide 70 wt %, conductive carbon SuperP 10 wt %, conductive carbon KS6 10 wt %, adhesive PVDF 10 wt % and slurry solvent 13.3 to 14.3 ml, with the total solid content of 57.7 to 55.8%.

Using a stirring device, the slurry was stirred at a rate of 2000 r.p.m. For 30 minutes to make the materials distributed uniformly. The slurry was coated on an Al foil by a blade with a gap of 200 μm. Then, the coated semi-finished product was placed in a constant temperature over at 120° C. for the dying treatment overnight.

After the dying treatment, a negative electrode having a thickness of 80 to 85 μm was obtained. Also, the negative electrode was adjusted to a thickness of 60 to 65 μm by rolling and cut through a sheeter to form a round negative electrode sheet with a diameter of 13 mm which was dried in vacuum at 120° C. for 8 hours before assembling.

Assembling of lithium ion secondary battery: Before assembly, the negative electrode sheet prepared above was weighed and soaked in an electrolyte composed of 1M LiPF₆ and a 1:1 (volume ratio) mixture of ethylene carbonate (EC) and diethyl carbonate (DEC) to clean the surface of the negative electrode sheet. Then, components including a battery lower cover, a lithium sheet, a separator membrane, the negative electrode sheet containing the titanium niobium oxide prepared in this Example, a stainless steel liner, a stainless steel connector and a battery upper cover were assembled from bottom to top in sequence. During the assembling, 47.7 μL of the electrolyte was added to soak the positive and negative electrodes of the battery therein. Thereafter, 1 ton gravity was applied for sealing to form a button battery.

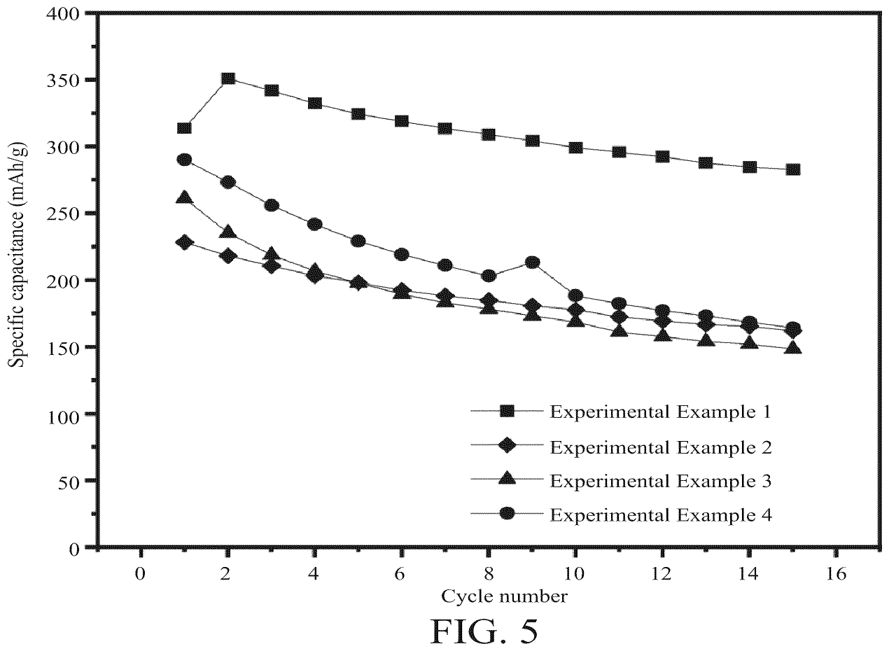

Finally, a cycle stability analysis was performed according to the assay methods described above and the results were recorded in FIG. 5, wherein the charging and discharging rate for the cycle stability analysis was 0.1 C.

### Experimental Example 2: Difference in Manner for the Mixing Procedure

The titanium niobium oxide and the negative electrode material containing the same and the lithium ion secondary battery were all prepared with the same methods as those in Experimental Example 1 except that, before the hydrolysis and condensation reactions, the mixing procedure was performed by directly pouting the second reaction solution into the first reaction solution for mixing. The lithium ion secondary battery was analyzed for its cycle stability according to the assay methods described above under the conditions of charging and discharging rate in the same Experimental Example 1, and the results were recorded in FIG. 5.

It can be seen from above, the manner of “added dropwise” in Experimental Example 1 can effectively control reaction rate and reduce defects in crystal structure and generation of impurities compared to the “direct” mixing in Experimental Example 2, thus, the titanium-niobium composite oxide prepared in Experimental Example 1 exhibited good cycle stability when applied in lithium ion secondary batteries.

### Experimental Example 3: Change in Temperature for Sintering Treatment

The titanium niobium oxide was prepared with the same method as in Experimental Example 1 except that the sintering temperature was adjusted to 900° C. Again, the prepared titanium niobium oxide was analyzed according to the methods described above for particle size and crystal properties. By the analysis, the number average particle size was 2.5 μm, the standard derivation of its distribution was 0.49 μm, and the crystal properties were recorded in FIG. 6.

Thereafter, a negative electrode material was prepared and a lithium ion secondary battery was assembled with the same methods as those in Experimental Example 1. The lithium ion secondary battery was analyzed for cycle stability according to the assay method described above under the same conditions of rate as Experimental Example 1, and the results were recorded in FIG. 5.

It can be seen from above, the titanium niobium oxide prepared in Experimental Example 3, which was sintered at a lower temperature, has a poor distribution uniformity and a crystal structure further comprising phases of Ti₂Nb₁₀O₂₉. In contrast, the titanium niobium oxide prepared in Experimental Example 1, which was sintered at a higher temperature, has more refined particle size, high distribution uniformity and more consistent crystal structure, and also exhibited good cycle stability when applied in lithium ion secondary batteries, suggesting the significant effect of sintering temperature on the product and application.

### Experimental Example 4: Change in Cooling Rate after Sintering

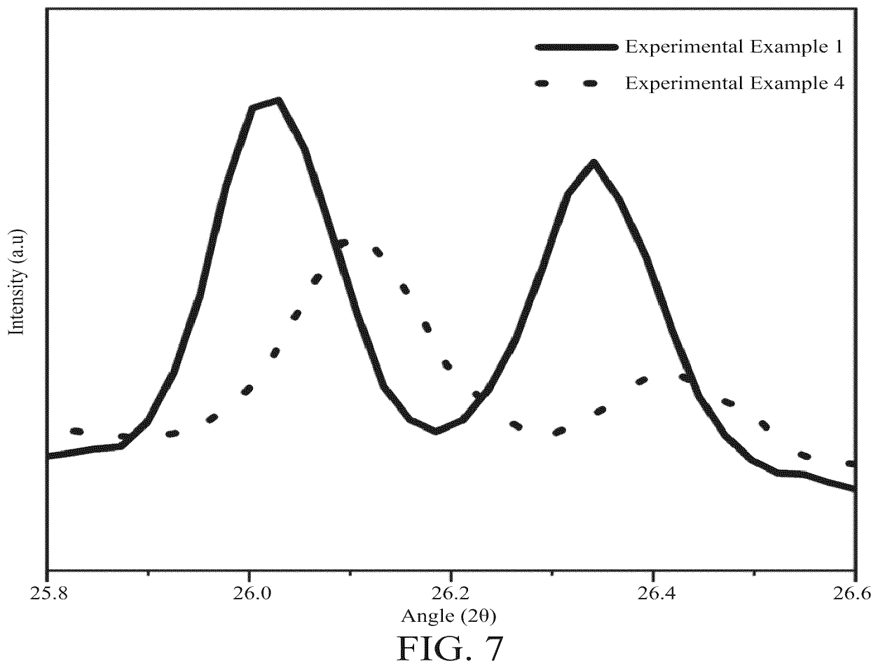

The titanium niobium oxide was prepared with the same method as that in Experimental Example 1 except the cooling rate after sintering was 3° C./min. Again, the prepared titanium niobium oxide was analyzed according to the method describe above for crystal properties, and the results of the crystal properties were recorded in FIG. 7.

Thereafter, a negative electrode material was prepared and a lithium ion secondary battery was assembled with the same methods as those in Experimental Example 1. The lithium ion secondary battery was analyzed for cycle stability according to the assay method described above under the same conditions of rate as Experimental Example 1, and the results were recorded in FIG. 5.

It can be seen from above, compared to the small cooling rate in Experimental Example 4, the x-diffraction spectra in FIG. 7 show that the diffraction peak for Experimental Example 4 had a tendency of shifting to a larger angle, suggesting that the crystal structure formed under a small cooling rate had a space more compressed. Therefore, by controlling the nucleation and growth rate of the crystal, the titanium niobium oxide from Experimental Example 1 had a space larger than that from Experimental Example 4 and reduced the internal resistance for lithium ions embedding when applied in lithium ion secondary batteries, thereby exhibiting excellent cycle stability.

### Preparation of Titanium-Niobium Composite Oxide

### Comparative Example: Titanium-Niobium Oxide

The titanium niobium oxide, the negative electrode material and the lithium ion secondary battery prepared in Experimental Example 1 were used, and methods and results of the analysis for properties aforementioned were referenced. Each axis size of a unit cell in the crystal structure was analyzed and recorded in Table 1.

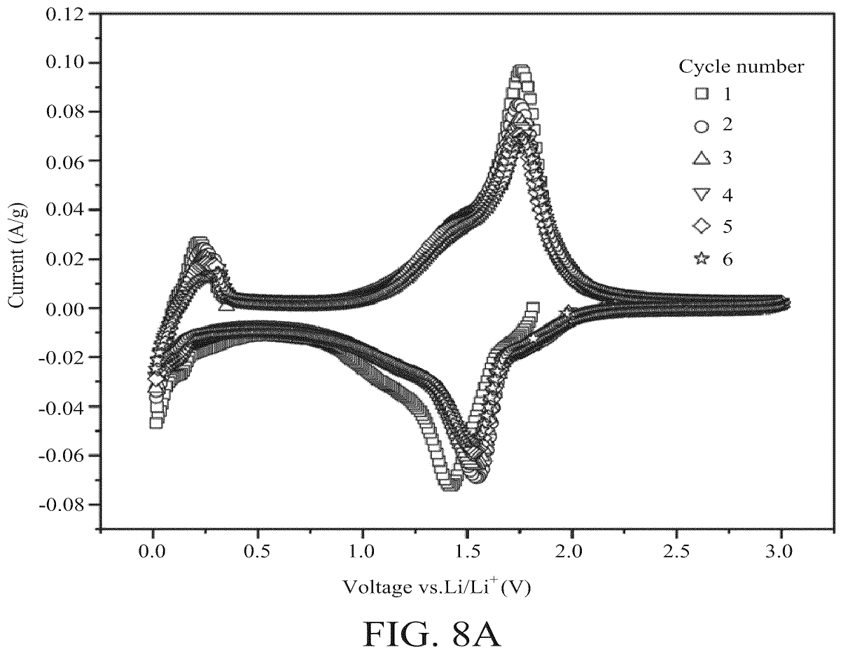

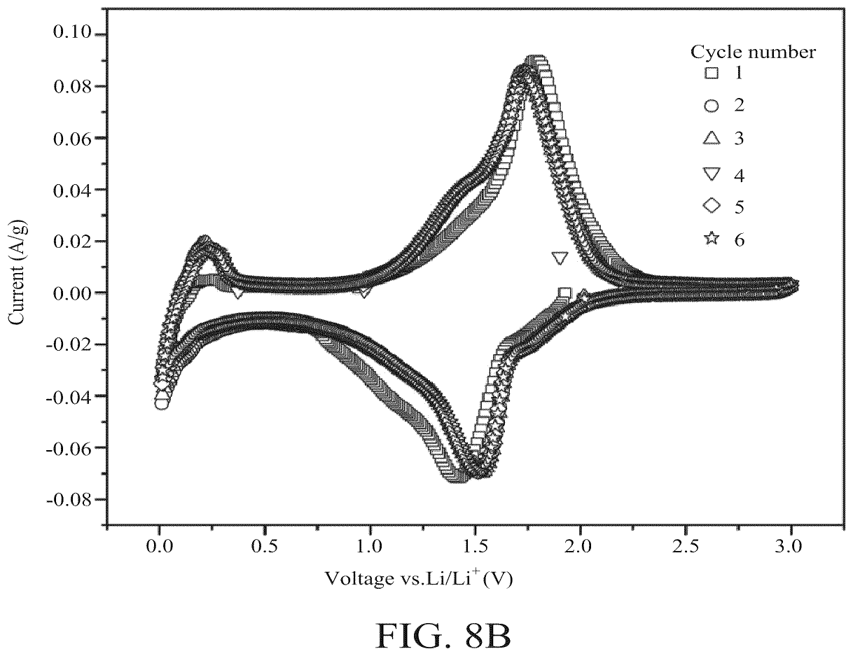

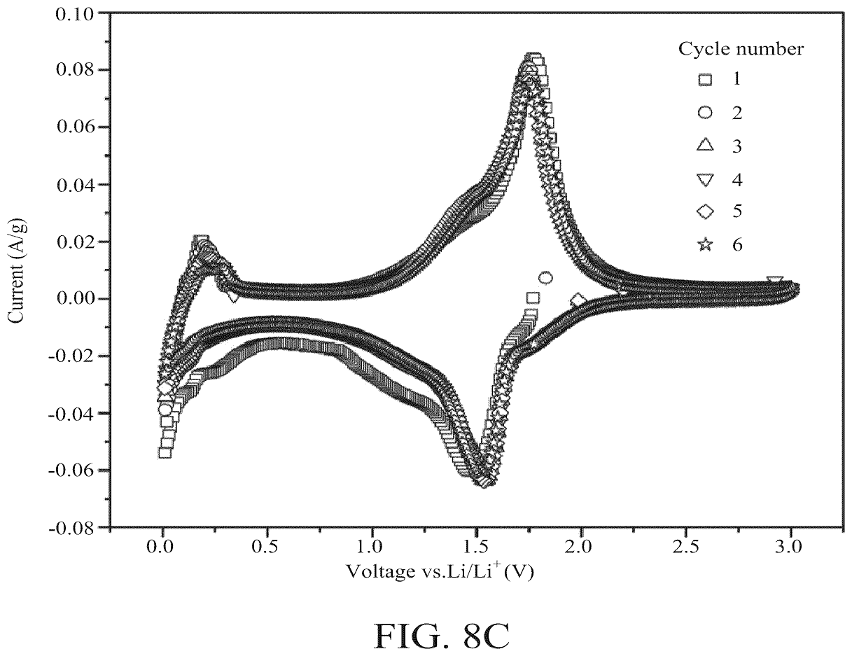

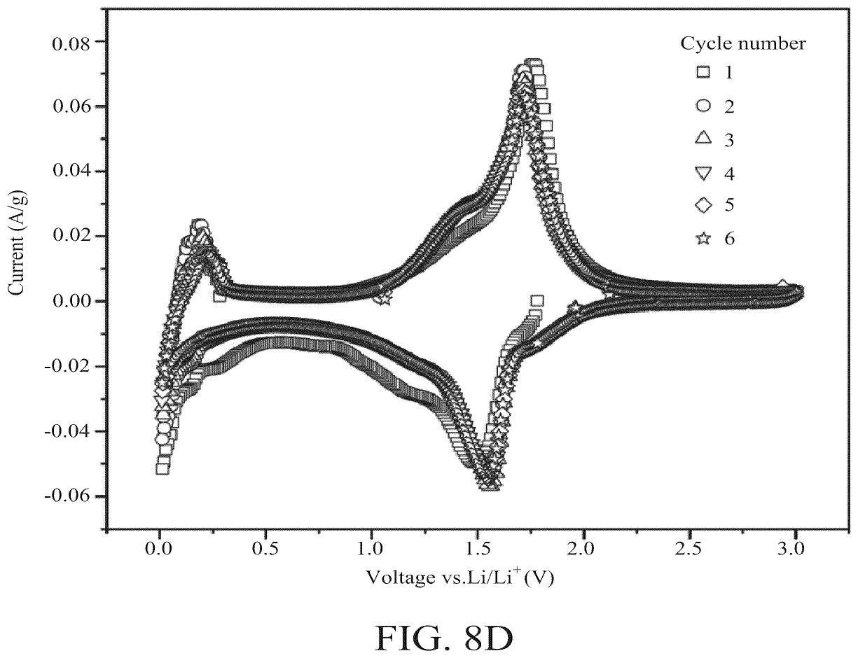

Thereafter, according to the assay methods aforementioned, the prepared lithium ion secondary battery was subjected to cyclic voltammetry test and analyzed for lithiation rate, impedance, rate discharging performance and cycle stability. The results were recorded in Table 2 and FIGS. 8 to 11, wherein the charging and discharging rate in the cycle stability analysis was 1 C.

### Example 1: Titanium-Niobium Composite Oxide Having a Dopant Al

The titanium-niobium composite oxide was prepared with the same method as Experimental Example 1, except the composition of the precursor salts was altered to be titanium isopropoxide (8.52 g) as titanium-containing metal salt, niobium ethoxide (18.8 g) as niobium-containing metal salt and aluminum acetylacetonage (0.291 g) as aluminum-containing metal salt, so that the molar ratio of titanium, niobium and aluminum in the mixed solution was 1:1.97:0.03, thus preparing the titanium-niobium composite oxide.

Thereafter, the prepared titanium-niobium composite oxide was analyzed with the analysis methods aforementioned for the surface morphology, particle size and crystal properties, and the results of surface observation and crystal properties were recorded in Table 1, FIG. 3 and FIG. 4. Among them, the measured number average particle size was 1.6 μm, the standard derivation of its distribution was 0.32 μm, and in term of the crystal structure, the ratio of diffraction intensity on lattice plane (110) to that on lattice plane (003) was 1.07±0.01.

Again, a negative material was prepared and a lithium ion secondary battery was assembled with the same methods as Experimental Example 1. Analyses were performed with the assay methods aforementioned for cyclic voltammetry test, lithiation rate, impedance, rate discharging performance and cycle stability, and results were recorded in Table 2 and FIGS. 8 to 11, wherein the charging and discharging rate of the electrical stability analysis was 1 C.

### Example 2: Change in Composing Proportion of the Dopant Al

The titanium-niobium composite oxide was prepared with the same method as Example 1, except that the amount of aluminum acetylacetonate in the composition of the precursor salts was altered to be 0.486 g, so that the molar ratio of titanium, niobium and aluminum in the mixed solution was 1:1.95:0.05, thereby preparing the titanium-niobium composite oxide.

Thereafter, the prepared titanium-niobium composite oxide was analyzed with the analysis methods aforementioned for the surface morphology, particle size and crystal properties. By the analysis, the measured number average particle size was 1.8 μm, the standard derivation of its distribution was 0.34 μm, and the results of the surface observation and crystal properties were recorded in Table 1, FIG. 3 and FIG. 4.

Again, a negative material was prepared and a lithium ion secondary battery was assembled with the same methods as Example 1. Analyses were performed with the assay methods aforementioned for cyclic voltammetry test, lithiation rate, impedance, rate discharging performance and cycle stability, and results were recorded in Table 2 and FIGS. 8 to 11.

### Example 3: Change in Composing Proportion of the Dopant Al

The titanium-niobium composite oxide was prepared with the same method as Example 1, except that the amount of aluminum acetylacetonate in the composition of the precursor salts was altered to be 0.681 g, so that the molar ratio of titanium, niobium and aluminum in the mixed solution was 1:1.93:0.07, thereby preparing the titanium-niobium composite oxide.

Thereafter, the prepared titanium-niobium composite oxide was analyzed with the analysis methods aforementioned for the surface morphology, particle size and crystal properties. By the analysis, the measured number average particle size was 1.6 μm, the standard derivation of its distribution was 0.33 μm, and the results of the surface observation and crystal properties were recorded in Table 1, FIG. 1, FIG. 3 and FIG. 4.

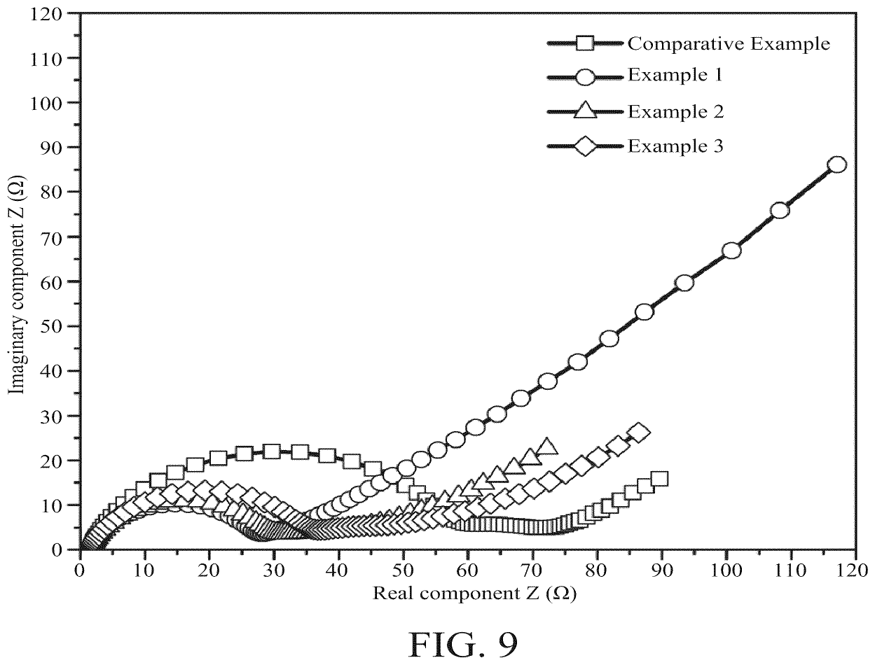

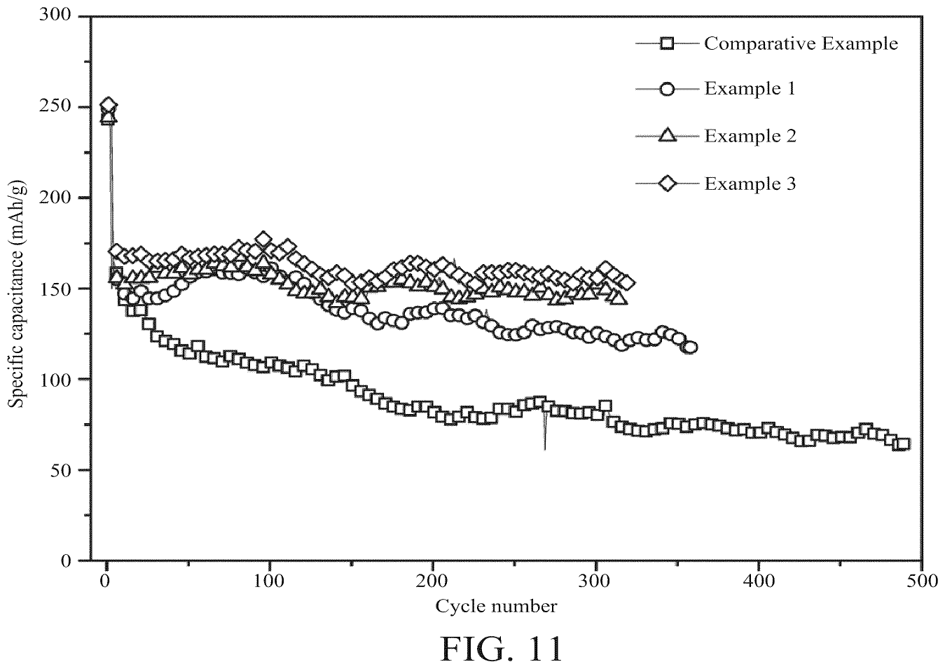

Again, a negative material was prepared and a lithium ion secondary battery was assembled with the same methods as Example 1. Analyses were performed with the assay methods aforementioned for cyclic voltammetry test, lithiation rate, impedance, rate discharging performance and cycle stability, and results were recorded in Table 2, FIG. 8, FIG. 9 and FIG. 11.

### Example 4: Titanium-Niobium Composite Oxide Having a Dopant Zr

The titanium-niobium composite oxide was prepared with the same method as Example 1, except that the amount of aluminum-containing metal salt in the composition of the precursor salts was altered to be zirconium acetylacetonate (0.438 g) as zirconium-containing metal salt, so that the molar ratio of titanium, niobium and zirconium in the mixed solution was 1:1.97:0.03, thereby preparing the titanium-niobium composite oxide.

Thereafter, the prepared titanium-niobium composite oxide was analyzed according to the analysis methods aforementioned for crystal properties, and the results of various axis sizes of unit cells were recorded in Table 1.

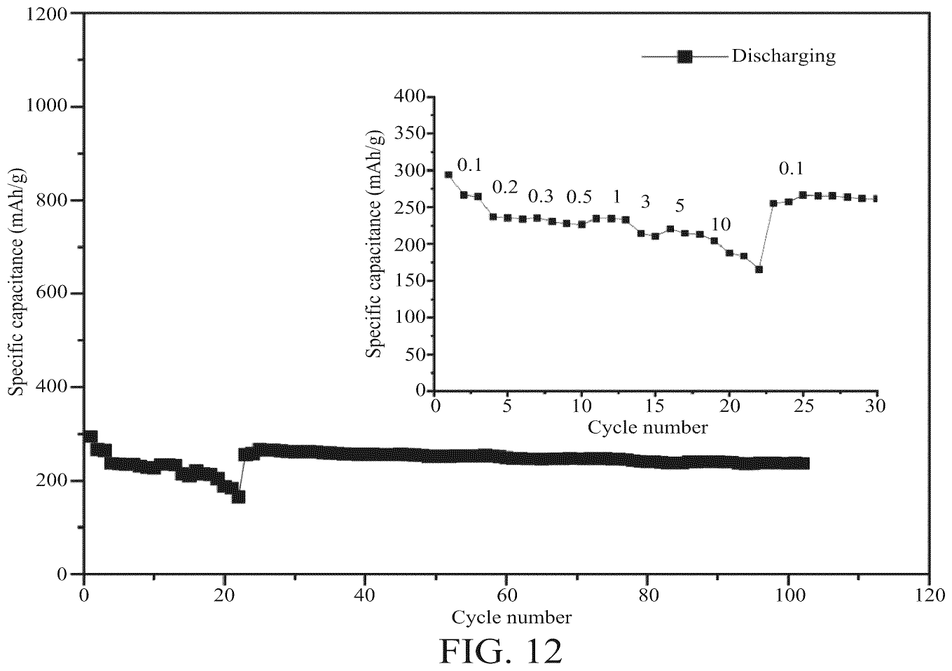

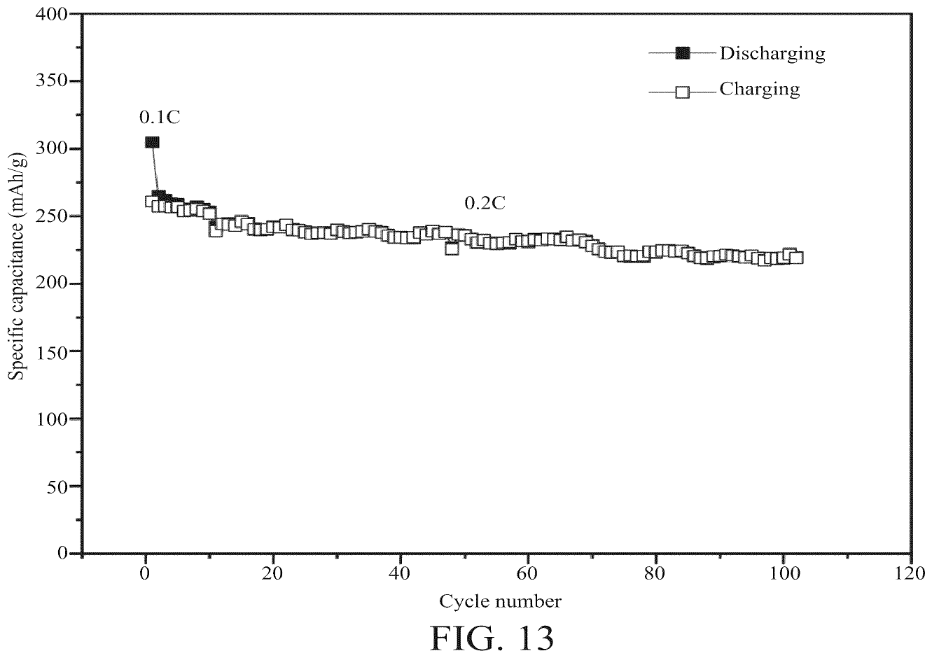

Again, a negative electrode material was prepared and a lithium ion secondary battery was assembled with the same methods as Example 1. The rate charging and discharging performance analysis and cycle stability analyses were performed according to the same assay methods aforementioned and the results were recorded in FIG. 12 and FIG. 13. In FIG. 12, the rates of the rate discharging performance analyses were adjusted to be 0.1 C, 0.2 C, 0.3 C, 0.5 C, 1 C, 3 C, 5 C and 10 C, respectively, and the cycle stability analysis was performed at a rate of 0.1 C. FIG. 13 represented the long-term charging and discharging cycle stability analysis performed at a rate of 0.2 C after 10 cycles at a rate of 0.1 C.

### Example 5 and 6: Change in Composing Proportion of the Dopant Zr

The titanium-niobium composite oxides were prepared with the same method as Example 1, except that the amounts of zirconium acetylacetonate as zirconium-containing metal salt in the composition of the precursor salts were altered to be 0.729 g and 1.023 g, respectively, so that the molar ratio of titanium, niobium and zirconium in the mixed solutions were 1:1.95:0.05 and 1:1.93:0.07, respectively, thereby preparing the titanium-niobium composite oxides.

Thereafter, the prepared titanium-niobium composite oxide was analyzed according to the analysis methods aforementioned for crystal properties, and the results of various axis sizes of unit cells were recorded in Table 1.

TABLE 1

| | Dopants | | | | | |
|---|---|---|---|---|---|---|
| | | Intro- | Lattice contant (Å) | | | Overall |
| | | duction | a- | b- | c- | volume |
| | Type | amount | axis | axis | axis | (Å³) |
| Comparative | None | 0 | 20.3766 | 3.79981 | 11.89960 | 795.9297 |
| Examples | | | | | | |
| Example 1 | Al | 0.03 | 20.3753 | 3.79894 | 11.89760 | 795.7167 |
| Example 2 | | 0.05 | 20.3820 | 3.79919 | 11.90420 | 796.2941 |
| Example 3 | | 0.07 | 20.3819 | 3.800 | 11.90330 | 796.437 |
| Example 4 | Zr | 0.03 | 20.4009 | 3.80255 | 11.9115 | 798.4945 |
| Example 5 | | 0.05 | 20.4055 | 3.80335 | 11.915 | 799.126 |
| Example 6 | | 0.07 | 20.4148 | 3.80502 | 11.9197 | 800.1813 |

TABLE 2

| | Dopants | | |
|---|---|---|---|
| | | Introduction | Lithiation |
| | Type | amount | rate |
| Comparative | None | 0 | 4.69e−9 |
| Examples | | | |
| Example 1 | Al | 0.03 | 5.13e−9 |
| Example 2 | | 0.05 | 7.90e−9 |
| Example 3 | | 0.07 | 6.53e−9 |

The results aforementioned were observed and compared to the Comparative Example, the introduction amount of the dopant Al had no significant effect on the space of crystal structure, but there was a tendency of significant increase in the space of crystal structure when the induction mount of the dopant Al reached 0.05 to 0.07 or the dopant Zr was alternatively introduced.

The characteristic differences described above also embodied on the performances in the application of batteries:

Comparing FIGS. 8A to FIG. 8D, after several cycles, the current peak at the reaction voltage (1.6V) showed that the current peak of the Comparative Example is significantly decreased, while those from Examples of the present invention could maintain a corresponding current peak, which was consistent with the cycle life results in FIG. 11.

Secondly, see the impedance diagram in FIG. 9, it was confirmed from the results of the arc and slope comparison that those from the Examples of the present invention had the effect of significantly reducing the internal resistance of the battery, which was also consistent with the lithiation rate results in Table 2.

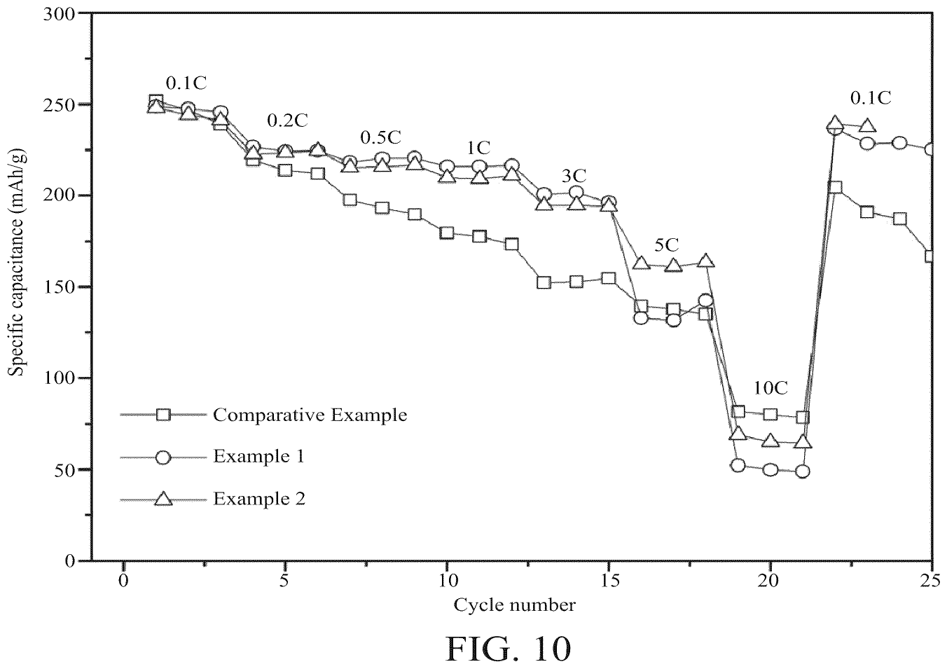

Also, see the analysis in FIG. 10 and FIG. 12, those from the Examples of the present invention had high electric capacities under high rate charge and discharge. When it returned to low rate after high rate charging and discharging, those from the Example of the present invention could also recover the initial electric capacities and maintained their capacitance in long-term cycle analysis (FIG. 12), suggesting that the materials obtained from the Examples of the present invention had better stability and did not change due to rapid charging.

It can be seen from above, the titanium-niobium composite oxide obtained from the Examples of the present invention exhibited larger electrical capacity, higher lithiation rate, lower internal resistance, faster charging and discharging rate and longer cycle life when applied on lithium ion secondary battery than those having no dopant added.

Taken together, by the introduction of the dopant M and the optimization of preparation conditions, the present invention makes the titanium-niobium composite oxide prepared to have better electrical performance than the existing negative electrode materials, so that the lithium ion secondary battery using it can exhibit longer cycle life, larger electric capacity and faster charging and discharging performance, thereby having a bright prospect of the application.

The above Examples are used for illustration only but not for limiting the present invention. Modifications and alternations can be made to above Examples by anyone skilled in the art without departing from the spirit and scope of the present invention. Therefore, the range claimed by the present invention should be defined by attached Claims and should be encompassed within the disclosure of the present invention as long as that doesn't influence effects and purposes of the present invention.

We claim:

1. A titanium-niobium composite oxide, comprising titanium, niobium, dopant M and oxygen, and a molar ratio of the titanium, niobium and dopant M is 1:(2−x):x, and x is 0.01 to 0.2,
wherein the dopant M is doped in a crystal structure with a monoclinic crystal structure formed from the titanium, niobium and oxygen, and the dopant M is at least one metal element selected from the group consisting of Sn, Al and Zr.

2. The titanium-niobium composite oxide of claim 1, wherein the crystal structure has the a-axis lattice constant of 20.375 Å to 20.415 Å, the b-axis lattice constant of 3.798 Å to 3.806 Å, and the c-axis lattice constant of 11.897 Å to 11.920 Å.

3. The titanium-niobium composite oxide of claim 1, which are particles having a number average particle size of 1.5 to 1.9 μm.

4. A preparation method of the titanium-niobium composite oxide of claim 1, comprising:
providing a first reaction solution and a second reaction solution, respectively, wherein the first reaction solution comprises a first solvent, more than two acid agents and a surfactant; the second reaction solution comprises a second solvent and precursor salts dissolved in the second solvent, and the precursor salts comprise a titanium-containing metal salt, a niobium-containing metal salt and an M-containing metal salt, in which the M is at least one metal element selected from the group consisting of Sn, Al and Zr;
mixing the first reaction solution and the second reaction solution in batches to form a mixed solution; and
subjecting the mixed solution to hydrolysis and condensation reactions to prepare the titanium-niobium composite oxide.

5. The preparation method of claim 4, wherein the titanium-containing metal salt is at least one selected from the group consisting of titanium isopropoxide, titanium citrate, titanium oxysulfate, titanium butoxide and titanium tetrachloride.

6. The preparation method of claim 4, wherein the niobium-containing metal salt is at least one selected from the group consisting of niobium isopropoxide, niobium pentachloride, niobium ethoxide and niobium hydroxide.

7. The preparation method of claim 4, wherein the M-containing metal salt is at least one selected from the group consisting of tin chloride, aluminum isopropoxide, aluminum trichloride, aluminum sulfate, aluminum acetate, aluminum acetylacetonate, zirconium acetylacetonate, zirconium isopropoxide and zirconium acetate.

8. The preparation method of claim 4, wherein the surfactant is at least one selected from the group consisting of polyoxyethylene-polyoxypropylene block copolymer, polyethylene glycol octylphenyl ether and hexadecyltrimethylammonium bromide.

9. The preparation method of claim 4, wherein the second reaction solution is added dropwise to the first reaction solution in batches for mixing, with the titanium-containing metal salt in the second reaction solution is added dropwise at a rate of to 0.10 moles/minute.

10. The preparation method of claim 4, wherein the precursor salts are included in the mixed solution at a molarity of 20 to 25 M, and a molar ratio of the surfactant and the titanium-containing metal salt in the mixed solution is 0.02:1 to 0.04:1.

11. The preparation method of claim 4, wherein the acid agents are at least two selected from the group consisting of sulfuric acid, hydrochloric acid, nitric acid and acetic acid.

12. The preparation method of claim 11, wherein the acid agents are hydrochloric acid and acetic acid, and a volume ratio of the hydrochloric acid and the acetic acid in the first reaction solution is 0.1:1 to 1:1.

13. The preparation method of claim 4, wherein the mixed solution has a pH value of 1 to 6.

14. The preparation method of claim 4, wherein the hydrolysis and condensation reactions are performed at a temperature of 80 to 100° C. for 1 to 6 hours.

15. The preparation method of claim 4, further comprising subjecting the titanium-niobium composite oxide to a drying treatment after the hydrolysis and condensation reactions, wherein the drying treatment is performed continuously at a temperature of 50 to 150° C. for 6 to 48 hours.

16. The preparation method of claim 4, further comprising subjecting the titanium-niobium composite oxide to a sintering treatment after the hydrolysis and condensation reactions, wherein the sintering treatment is performed continuously at a temperature of 800 to 1400° C. for 3 to 20 hours.

17. The preparation method of claim 16, further comprising allowing the sintered titanium-niobium composite oxide to cool down at a cooling rate of 4.5 to 8 ° C./minute.

18. A lithium ion secondary battery, comprising:
a positive electrode;
a negative electrode comprising the active substance comprising the titanium-niobium composite oxide of claim 1; and
an electrolyte located between the positive and the negative electrodes.

19. The lithium ion secondary battery of claim 18, wherein the titanium-niobium composite oxide is included at a weight percentages of 60-80 wt % in the negative electrode.

20. The lithium ion secondary battery of claim 18, having a lithiation rate of 5.1e-9 to 6.6e-9.
